(19) United States
(12) Patent Application Publication
(10) Pub. No.: US 2022/0258606 A1
(43) Pub. Date: Aug. 18, 2022

(54) METHOD AND OPERATING SYSTEM FOR DETECTING A USER INPUT FOR A DEVICE OF A VEHICLE

(71) Applicant: Volkswagen Aktiengesellschaft, Wolfsburg (DE)

(72) Inventor: Astrid Kassner, Berlin (DE)

(21) Appl. No.: 17/625,321

(22) PCT Filed: May 13, 2020
(86) PCT No.: PCT/EP2020/063395

§ 371 Date: Jan. 6, 2022

(30) Foreign Application Priority Data
Jul. 8, 2019 (DE) 10 2019 210 010.4

(51) Int. Cl. B60K 35/00

(52) U.S. Cl. CPC B60K 35/00; B60K 2370/1464; B60K 2370/1468; B60K 2370/148; B60K 2370/741; B60K 2370/191; B60K 2370/193; B60K 2370/199; B60K 2370/15

(57) ABSTRACT

Technologies and techniques for detecting a user input for a device of a vehicle, an operable function of the device is detected and a first and a second potential operational action type depending on the operable function. A preferred operational action type is determined and an output is generated depending on the preferred operational action type. The output includes an operating object, dependent on which the preferred operational action type is displayed to the user. The operating system includes a control unit and an output unit. The control unit detects an operable function of the operating system, to determine a first and a second potential operational action type for the operable function depending on the operable function, and determines a preferred operational action type. The control unit generates an output depending on the preferred operational action type and to output the output by means of the output unit.

### RELATED APPLICATIONS

The present application claims priority to International Patent App. No. PCT/EP2020/063395 to Astrid Kassner, filed May 13, 2020, which further claims priority to German Pat. App. No. 10 2019 210 010.4 filed Jul. 8, 2019, the contents of each being incorporated by reference in their entirety herein.

### TECHNICAL FIELD

The present disclosure relates to a method and an operating system for detecting a user input for a device of a vehicle.

### BACKGROUND

Modern everyday life is characterized by a large number of devices that can be operated in different contexts in different ways. Various operating concepts have been proposed for this purpose, for example control by means of keyboards, gestures, speech or pointing devices that have specific advantages and disadvantages depending on the area of application. In some cases one can also achieve the same system reaction with different operating modes can be provided that a user knows and between which he has to decide.

It has been shown that the choice between different operating modalities or different operating options in order to provoke a certain system reaction can overwhelm the user. The types of operational actions available can be learned, for example, using a manual or an introductory video, for example by playing a video when the system is first started up and/or can be called up again later. The user is often confronted with a larger amount of information than he can process, and he has to spend considerable time learning the operation.

US 2015/0175172 A1 describes a system for gesture-based inputs with haptic feedback. A gesture is detected and a corresponding feedback is given. Speech control can also be used. Various gestures are described which can be detected by means of a camera and which are assigned to the various controllable actions of the system.

From US 2004/0189720 A1 an architecture for controlling a computer by means of gestures is known, in which gestures can be used in combination with voice commands.

DE 10 2009 039 114 A1 proposes an operating device for a vehicle in which a part of the body of a user is detected in one of three spatial areas and an assigned object is displayed in the case of a graphic object. For example, a number and a scale can be displayed.

US 2018/0307347 A1 describes a method for detecting gestures using a capacitive sensor. The user can define gestures in a database for certain commands and learn prescribed gestures by looking at instructions.

From DE 10 2006 037 156 A1 a method is known for operating an interactive control device in which a control element is displayed and an approach of a user to the control element is detected. The control element is then displayed in an optimized way, for example by enlarging it. The adaptation of the display can also be controlled by means of a gesture.

### BRIEF SUMMARY

The present disclosure is based on aspects of providing a method and an operating system in which a user is supported in recognizing and using various operating options.

According to the present disclosure, various aspects are directed to methods and operating systems including features described in the independent claims. Advantageous embodiments and further developments result from the features of the dependent claims.

In some examples, a method is disclosed for detecting a user input for a device of a vehicle, an operable function of the device is detected and a first and a second potential type of operational action are determined as a function of the operable function. A preferred type of operational action is determined, and an output is generated and output as a function of the preferred type of operational action. In this case, the output includes an operating object, on the basis of the preferred operational action type is displayed to the user.

As a result, a user can advantageously see which type of operation is currently preferred and which inputs are particularly suitable.

In the method an operable function is first detected. In particular, it is detected which function or which functions can currently be operated. This can be, for example, a state of a device in which a user input or another interaction of a user with the device can be detected. At least one operational action is provided for operation, by means of which the user can interact with the device. When the user interacts with the device, for example, an operational action by the user is detected by the operating system and a control signal is generated and transmitted to the device in order to activate or deactivate a function, to enter an adjustable parameter or to transfer an instruction to the device.

In the case of an operation, a certain type of operational action can be assigned to an operational action by means of which a function can currently be operated. That means in particular the specific operational action actually carried out by the user is assigned to an abstract model of an operational action.

In the method, at least a first and a second potential type of operational action for the operable function are determined depending on the operable function, in particular, more potential operational action types can also be determined. That is, after it has first been determined which functions can currently be operated, it is also determined which types of operation are possible and in which ways, e.g., by means of which operating modalities and/or by means of which operational action types, this operation can be carried out. For example, in a current operating situation and a state of the operable function, certain gestures, voice commands or other types of operational actions can be used, while other types of input cannot currently be used for operation. For example, in a certain state of the operable function, vertical scrolling can be carried out, but no lateral shift or vice versa. Accordingly, certain commands or types of operational actions may or may not be usable in this situation.

In some examples, an operating system is disclosed for detecting a user input for a device of a vehicle comprising a control unit and an output unit that is coupled to the control unit. The control unit is set up to detect an operable function of the operating system, to determine a first and a second potential operational action type for the operable function depending on the operable function, and to determine a preferred operational action type. Here the control unit also set up, depending on the preferred operational action type, to generate an output and output it by means of the output unit. In this case, the output comprises an operating object, by means of which the preferred type of operational action is displayed to a user.

The operating system according to the present disclosure is designed in particular to implement the method described herein according to the present disclosure. It thus has the same advantages as the method according to the present disclosure.

The output unit can be designed in various ways. It can, for example, include a display surface on which a graphic representation can be output during output. It can also include a device for outputting acoustically detectable outputs, in particular speech outputs. The output unit can also be suitable for generating an output with a three-dimensional representation, for example as a holographic or autostereoscopic output.

In some examples, the operating system may include an identification device that is set up to detect a user identification. The control unit may also be configured to detect the operating history for the potential type of operational action for the user identified. As a result, the output can advantageously be adapted in a particularly targeted manner to the needs of the respective user.

In some examples, the operating system may include a detection unit for detecting an operational action, in particular with a camera for detecting a gesture in a detection area, a touch-sensitive surface and/or a speech detection unit. This advantageously allows different operational action types to be easily detected for the control of the operating system.

In some examples, a vehicle may be configured to include an operating system as described herein.

### BRIEF DESCRIPTION OF THE DRAWINGS

The present disclosure will now be explained on the basis of exemplary embodiments with reference to the drawings.

FIG. 1 shows a vehicle with an exemplary embodiment of the operating system according to some aspects of the present disclosure;

FIG. 2 shows an exemplary embodiment of the method according to some aspects of the present disclosure;

FIG. 3 shows an exemplary embodiment of an output generated in the method according to the present disclosure with a reference to the implementation of an operating gesture under some aspects of the present disclosure;

FIG. 4 shows an exemplary embodiment of an output generated in the method under some aspects of the present disclosure; with references to different directions;

FIG. 5 shows an exemplary embodiment of an output generated in the method some aspects of the present disclosure with a popup for volume control;

FIGS. 6A and 6B show exemplary embodiments of outputs generated in the method according to some aspects of the present disclosure with instructions for executing operating gestures;

FIG. 7 shows an exemplary embodiment of output generated in the method according to some aspects of the present disclosure with a popup to control a lighting device; and

FIGS. 8A to 8D show an exemplary embodiment of an output generated in the method and its operation in different operating modes under some aspects of the present disclosure.

### DETAILED DESCRIPTION

In some examples disclosed herein, a potential operational action type comprises a gesture in three-dimensional space, a gesture on a touch-sensitive surface, voice input or operation of a push, slide or rotary switch. A type of operational action can also include, for example, pressing a button, rotation or another actuation of an operating element. In particular, the potential types of operational actions are selected from the types of operation mentioned. As a result, a user can advantageously be supported particularly well in carrying out suitable operational actions.

For example, a spoken utterance may be detected by means of a microphone and the utterance detected is assigned to a specific voice command. It is taken into account that the utterance actually detected typically does not correspond exactly to the predefined, idealized model of the type of operational action of the specific speech input, but that there are deviations, for example due to noise during the detection, background sounds and inconsistent sound generation when the voice command is uttered. In a similar way, for example, a gesture can be detected in a three-dimensional space and assigned to a swiping gesture in a certain direction, whereby a model of the corresponding operational action type is determined for an actually detected gesture.

Furthermore, operating modalities in particular may be defined that combine a set of specific operational action types, in particular through common characteristics of the generation, implementation and/or detection of the operational action types of an operating modality. Thus, one operating modality, “voice input”, can include different operational action types, in particular various individual voice commands. In a further example, an operating modality “gesture operation” for the three-dimensional space can comprise various gestures, such as swiping gestures right and left, swiping gestures up and down, a confirmation gesture and/or a pointing-and-shifting gesture, which can be defined as a volume gesture, for example. Further operating modalities can be, for example, gestures on a touch-sensitive surface or actuations of physical operating devices.

In some examples, at least two potential operational action types may be determined for the operable function and the first or the second potential operational action type may be determined as the preferred operational action type. The operating object of the output is then used to display which is the preferred operational action type. As a result, a user can advantageously be signaled which type of operational action is currently particularly well suited for operation.

For example, an operable function can be operated using different types of operational actions or operating modalities, using speech input, three-dimensional gestures and operation using gestures on a touchscreen. However, depending on the current situation and/or a current status of the operable function, it can be determined that a certain type of operational action or an operating modality is preferred, such as speech input or gesture operation, because the user is using his hands for other purposes, because an operating element or a detection space is better or less accessible for performing a gesture, because background noises interfere with the detection of a speech input or based on personal preferences of the user.

In some examples, the output may include an operating object, that is to say an operable element, on the basis of which the preferred type of operational action can be output. The operating object can be designed, for example, as a graphic element of a display on a display, in which case it defines an area of a display area of the display in which an actuation leads to an operation of the operating object. The actuation can take place by touching a touchscreen using an actuation object in the area of the operating object or by actuation using a pointer instrument, such as a cursor controlled by a mouse or a similar device. Furthermore, in this case, actuation can take place by means of a gesture, with no need to touch a touchscreen or an input device, for example by means of a pointing and actuation gesture.

The operating object can furthermore include a physically actuatable device, for example a pushbutton switch, a controller or another device. In this case, its representation is not changed as such during the output, but the output takes place, for example, in the area of the operating object.

In some examples, the operating object may be output in such a way that the preferred type of operational action is displayed. This means in particular that the user can determine in which way he can carry out the preferred type of operational action. In particular, the operating object itself can also be actuated to carry out an operational action.

For example, an actuation of the operating object may be provided as the first type of operational action for an operable function by touching a touchscreen in the area of the display of the operating object, and a spatial gesture in three-dimensional space can be performed as a further type of operational action. If gesture operation is preferred in this example, the display of the operating object can be formed with a dynamic movement within the display in such a way that it is already output to the user how he must perform the preferred operating gesture. In particular, the output may be made so that both the first and the second potential operational action type are displayed to the user, but the preferred operational action type is highlighted or displayed particularly clearly.

In some examples, the specific potential types of operational action are assigned to different operating modalities, a preferred operating modality is determined and the preferred type of operational action is determined on the basis of the preferred operating modality. As a result, a current operating situation can advantageously be classified particularly simply in order to determine which operational action type is particularly well suited.

For example, parameters of a situation may be detected, such as a driving mode, a mental or physical state of the user, in particular the driver, the complexity of a traffic situation, or a user input, and based on the parameters detected, operational action types of a certain, preferred operating modality are always output as preferred operational action types. For example, gesture operations may be preferred in a certain situation, such as in the case of an at least partially automatic vehicle control.

In particular, the following operating modalities may be defined in some examples: spatial gestures in a three-dimensional space, gestures on a two-dimensional surface, actuations by touching or pressing an actuating element such as a switch or button, actuation by means of a pointing element, for example a cursor, a mouse, a joystick, a rotary push-button or a touchpad, or voice commands. Operational action types are then, for example, specific gestures or voice commands for operation.

For example, an actuation object, in particular a hand of the user, can be used to carry out a gesture. In the following explanations, information relating to the hand of a user as an actuation object should be generalized to other actuation objects, such as a pen.

A “gesture” means in particular a certain position and/or orientation, that is to say a pose of an actuating object, for example a hand of a user, or a certain movement that is performed with the operating object. Gestures can be designed in a manner known per se. They include for example pointing gestures, swiping gestures and those gestures that are used in everyday use, such as hand turns, gripping gestures and combinations of several such gestures, possibly executed in quick succession. The gestures are carried out in a detection space. This can have a spatial reference to a specific device, for example an output device, and can, for example, adjoin this. A gesture can furthermore include an approach to a specific spatial position, for example a device or a position on a display surface. Gesture operation provides the user with a particularly simple and intuitive operating option.

A direction in space can also be determined on the basis of a gesture and, depending on the direction determined, in particular a position can be determined for which a pointing gesture is determined. For example, the user can point to a point in a display area and thereby make a selection. A selection of a graphic object can then be visualized if the graphic object lies in a predetermined surrounding area around the calculated point. This allows the graphic object to be selected by pointing. A visualization of the selection of a graphic object has the advantage that the user receives immediate feedback on his operational action. The point can be visualized in the display area even if no object has yet been identified in the surrounding area around the point. This avoids the user having to search in space between the objects until he has found the desired graphic object. This can further accelerate the selection process.

A gesture can be detected in a contactless manner by a camera system that detects time-resolved video data from the detection space and assigns the detected user movements to specific gestures by means of a connected analysis unit. Alternatively or additionally, a gesture can be detected by means of resistive and/or capacitive surfaces.

In a further embodiment, if the preferred type of operational action includes a spatial gesture, the output may include a moved object that has a movement corresponding to a direction of the spatial gesture. In this way, a gesture as the preferred type of operational action is advantageously output in a particularly easy-to-grasp manner and can be learned quickly and intuitively by the user. The movement can in particular be shown in perspective in the output.

For example, the potential types of operational actions can include certain gestures and control by means of touching a touchscreen. The operating object can then be designed as a moving object whose direction or sequence of movement corresponds to a movement of the potential type of operational action. This means that the user has to reenact the displayed movement sequence with an actuating object such as his hand. At the same time, in the example, the operating object shown can be designed to be self-actuatable and, for example, can be operated by means of a touch.

In some examples, if the preferred type of operational action includes a spatial gesture, the output includes a schematic graphic representation of a hand. As a result, a user can advantageously detect an input option particularly well by means of a gesture of his hand.

The output, with reference to the execution of a gesture in the three-dimensional space, may include, for example, a graphic representation of an operating object, such as a human hand. The representation is in particular designed schematically, whereby for example only the outlines of the actuation object are displayed. The graphic representation can be output on a display surface of a display unit, for example superimposed in addition to a further display. In particular, a display with a user interface can be generated on the display surface, which is overlaid by the graphic representation of the operational action by means of the actuation object. Moreover, in addition to a three-dimensional gesture, as operational action type, a touch or gesture on a touch-sensitive surface and/or a voice command can also be provided as a potential operational action type. In particular, a schematic hand representation is generated so that it has the size of an actual hand and a projection of the arrangement of a hand relative to the output surface can be displayed for a spatial gesture.

In one embodiment, if the first, preferred type of operational action comprises a voice command, the output comprises a text representation of the voice command. The user can advantageously decide quickly whether he wants to carry out the operation by means of the voice command or by means of another type of operational action. Alternatively or additionally, the output can include an acoustically perceptible reference to the voice command.

In some examples, an operating history for potential operational action types is also provided in the method and the preferred operational action type is also generated on the basis of the operating history.

The operating history may include information about a frequency of use and/or an execution quality of a potential type of operational action. As a result, the specific use of a particular type of operational action can advantageously be evaluated particularly well.

The operating history may include, for example, stored data on the use of operational actions of a certain operational action type, possibly in connection with an operable function, in particular regarding the frequency of use when the operational action type is preferred, and/or a specific recognition reliability during execution determined in use. The operating history may include, for example, information about how often an input was carried out by means of an operational action of a certain operational action type for an operable function. It may further include, for example, how often an operational action type is used if this operational action type was determined as the preferred operational action type.

In particular, a user identification of a user is detected and the operating history is detected for a potential type of operational action for the identified user. This can advantageously improve the use of a type of operational action for a specific user.

The user identification may be detected in a manner known per se. For example, a personal item, such as a mobile user device, a vehicle key, an identification card or other device, a user input or an optical user identification procedure can be used.

The operating history is generated in particular for an identified user, so that the abilities and/or habits of the user can advantageously be assessed. For example, the operating history can be used to determine whether and/or how often a user carries out operational actions of a certain type when this is available for an input or for calling up a function, and how often instead of the operational action type uses an operational action of a different type, in particular a non-preferred operational action type. The operating history can for example be stored on a mobile user device or accessed using the user identification, such as by accessing an external storage unit such as a server or an internal storage unit, such as that of a vehicle.

It can further be determined in which way a user carries out an operational action; for example, the certainty with which an operational action of a type is recognized can be determined, and/or an execution quality for an operational action can be determined. For example, in the case of a gesture, it can be determined with what certainty or confidence the gesture can be assigned to a specific type of operational action, in particular in order to distinguish the operational action from other types of operational action. Furthermore, an execution parameter can be determined, such as a clarity, a speed or an execution space.

If the type of operational action includes a gesture performed in space, it can, for example, be determined in which detection area in the space the gesture was carried out, how clearly, for example, a movement or pose of an actuation object is pronounced, with what amplitude or speed a movement is carried out or for what period of time a certain pose is held. Furthermore, various speech inputs can be available as types of operational action. The operating history can then include how clearly a speech input was recognized and/or with what input quality the speech input was detected, for example as a function of a volume, a speaking direction, a speaking speed, an intonation or speech articulation. The reference to the execution of the potential type of operational action can then be generated in such a way that the user can see from the output how the potential operational action type can be carried out better.

For example, an operational action is detected, assigned to an operational action type, and the operating history for the operational action type is updated on the basis of the operational action detected. The operating history can furthermore also be updated if it is detected that a user is not performing any operational actions of a potential operational action type, in particular if this is a preferred operational action type. As a result, the operating history is advantageously always kept up to date and the output can be adapted to the needs of the user.

In this case, the operating history can, for example, be supplemented with additional information or existing information can be updated with updated information. For example, the frequency with which the type of operational action is used by the user can be updated. Furthermore, information that relates to the quality of execution of the operational actions can be supplemented or updated; for example, the quality and/or clarity with which a user carries out operational actions of a certain type can improve and this can be detected and saved in the operating history.

In one embodiment, the operating history may include a prescribed period of time or a prescribed number of operational actions by a user or for a specific operable function. The operating history can further include a variable period of time, wherein it is first determined for the method which scope of the operating history is to be taken into account. For example, the operating history can be taken into account for a shorter period of time if a user is first learning the operation, as this involves greater changes in the operating behavior is to be expected. In contrast, after a longer duration in which the user has become familiar with the operating system, a longer period of time of the operating history can be taken into account in order to generate the output using a larger database and to offer the user more targeted support.

On the basis of the operating history, for example, operational action types that a user performs particularly frequently or in a clearly recognizable manner can be determined as preferred. Conversely, those types of operational actions that a user carries out seldom or that are difficult to recognize cannot be determined as preferred.

Furthermore, it can be detected that the user is carrying out an operational action that cannot be assigned to a potential operational action type, for example because the user is using a type of operational action that is currently not available, or because the operational action cannot be assigned to a known operational action type. For example, the user makes a swiping gesture, although no corresponding input is currently possible, or he makes a gesture indistinctly, for example over too small a space, too fast or imprecisely. It can then be recognized that the user wants to make an input, but that he does not seem to know which types of operational actions are available and/or how potential operational actions are to be carried out correctly.

In some examples, an operational action may also be detected that cannot be assigned to any potential operational action type, and an intention hypothesis is determined on the basis of the operable function and the operational action detected. The output is generated based on the intention hypothesis. In this way, a more suitable operating option can advantageously be proposed to a user. In particular, it is recognized which type of operational action the user probably wanted to use.

The output can then include, for example, an indication of how the potential type of operational action is to be carried out according to the intention hypothesis. Furthermore, the output can be generated to show the user which potential operational action types can currently be carried out and which is the preferred operational action type.

When determining the intention hypothesis, probabilities for various potential types of operational actions can be determined and compared, for example, and the operational action type with the highest probability can be used as the intention hypothesis. The probabilities can be determined on the basis of a similarity to the operational action actually detected; in this case, for example, a type of operational action can be recognized even if the operational action was not carried out clearly enough. Furthermore, the operating history can be used to determine an operational action which the user uses particularly frequently for the operable function. In a combination, weighting can also be used to determine which operational action types according to the operating history are used particularly frequently for the operable function and to which of these operational action types the operational action actually detected is particularly similar. Furthermore, it can be taken into account which potential types of operational action are available and the most likely of these operational action types can be selected as the intention hypothesis. In particular, the user can be asked to confirm that the intention hypothesis is the actually intended type of operational action.

In some examples, a user position relative to an input device is detected and the preferred type of operational action includes an actuation of the input device or a spatial gesture as a function of the user position. As a result, preferred types of operational actions and/or operating modalities can advantageously be determined particularly easily.

For example, a seated position of the user in an interior, such as that of a vehicle, can be detected. If the seat is in a position far back in the interior, e.g., at a great spatial distance from an input device such as a touchscreen, then the preferred type of operational action can include a spatial gesture, while operation by actuating or touching the touchscreen or another control element is not preferred. A range of the user can also be detected, for example an arm's length, or a predefined value of the range can be assumed, and in this case actuation or touching of a touchscreen or operating element can be the preferred type of operational action if it is within the range of the user.

An orientation of the user in the interior space, in particular relative to a certain marked direction, for example a direction of travel or a direction forwards or backwards in the longitudinal direction of a vehicle, can also be detected and taken into account when determining the preferred type of operational action. For example, a line of sight or an orientation of a seat can be determined. A preferred type of operational action can then be determined depending on the orientation of the user. For example, it can be determined in this way whether a certain operating element is arranged in a direction that is ergonomically accessible for the user, for example in an area in front of the user instead of behind him.

In one embodiment, a selection operational action may be detected and an operable device is determined on the basis of the selection operational action detected. The operable function is determined based on the particular operable device. In particular, the selection-operational action is designed as a pointing gesture. As a result, the operable function can advantageously be selected in a particularly simple and targeted manner.

For example, a user can point to a device in the vehicle with an actuation object, in particular with a finger, in particular by means of a specific pointing pose, and this is then selected for operation. Such functions of the device are identified as operable functions that can be operated in the current situation by an operational action. For example, by pointing to a sliding door, this can be selected and a sliding or swiping gestures can be determined through which a door opening or closing can be controlled as an operable function. Similarly, windows, flaps, lighting devices and/or seat adjustments, for example, can be controlled.

In some examples, the output is output visually, acoustically or as haptically perceptible. The output can thereby advantageously be output in a particularly easy-to-grasp manner well-adapted to the respective situation.

The output can take place in a manner known per se, for example by means of a display surface or a loudspeaker. Furthermore, a representation that appears three-dimensional can be output, for example by means of a holographic or autostereoscopic representation.

The output can also take place depending on an orientation of the user in the interior space, in particular a visually perceptible output by means of an output device in the user's field of vision.

The output may occur in a manner known per se. For example, a visually perceptible output can be output by means of a screen; furthermore, illuminated displays, for example with backlit symbols, can be used. An acoustically perceptible output can be output using a loudspeaker, for example.

The output takes place in particular by means of an output device that is determined as a function of an operating modality of the preferred operational action type. For example, the output is in a visually perceptible manner, if the preferred operational action type comprises actuating a touchscreen or an operating element by touching it. Furthermore, the output may take place, for example, in an acoustically perceptible manner if the preferred type of operational action comprises a voice command. In a further example, the output is acoustically perceptible if it is determined that an output device for visually perceptible output is not in the user's field of vision, for example because the user is looking in a different direction or his seat is oriented so that the view of the user sitting on it is turned away from the output device.

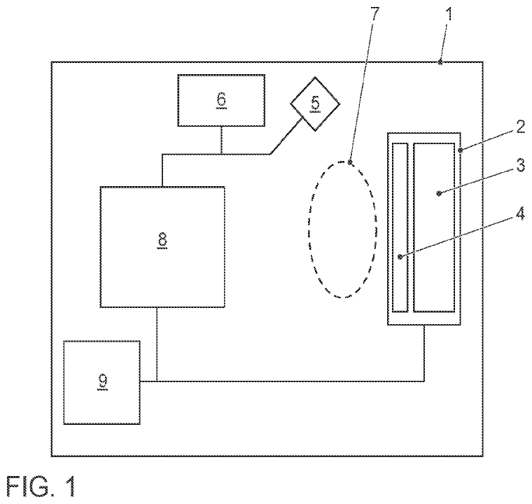

With reference to FIG. 1, a vehicle with an exemplary embodiment of the operating system according to the present disclosure is shown.

The vehicle 1 includes a touchscreen 2, which is configured in a manner known per se and includes a display unit 3 and a touch-sensitive surface 4 arranged above it. The vehicle 1 also includes a detection unit 5, which is designed as a camera 5 and through which gestures can be detected in a detection area 7 in the interior of the vehicle 1, and an output unit 6 designed as a loudspeaker 6. The touchscreen 2, the camera 5 and the loudspeakers 6 are coupled to a control unit 8 to which a multimedia unit 9 is also coupled.

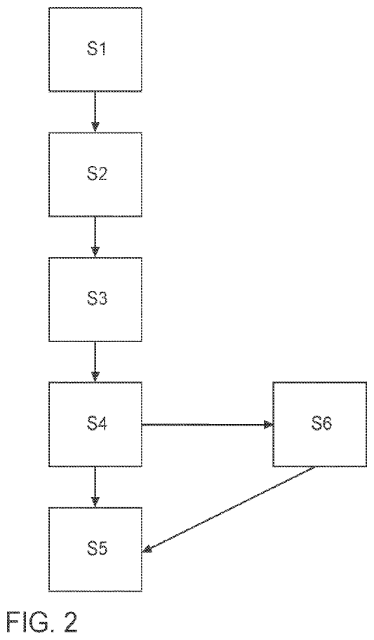

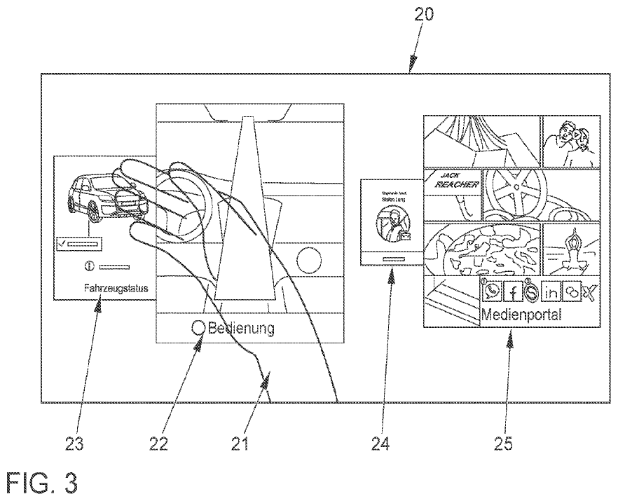

With reference to FIGS. 2 and 3, an exemplary embodiment of a method according to the present disclosure and an output generated thereby are explained with a reference to the implementation of an operating gesture. Here the above exemplary embodiment with reference to FIG. 1 of the operating system according to the present disclosure is assumed, which is further specified by the description of the method.

In a step S1 it is detected which functions are currently operable. For this purpose, it is determined which devices can currently be controlled by the control unit 8 and are in a state in which inputs from a user can be processed. In the exemplary embodiment functions of the multimedia unit 9 are operable, for example functions for outputting audiovisual content, texts and images for control of a navigation device, for access to other devices of the vehicle 1 or for controlling a telecommunication device, such as a telephone. A user can also navigate through hierarchically arranged databases, such as music titles or address data, or menu structures. In further exemplary embodiments, other functions and/or devices of the vehicle 1 can alternatively or additionally be operable.

In the exemplary embodiment, the identity of the user is also detected in this step S1. In the exemplary embodiment, this is done using a mobile device that is assigned to the user, in particular a vehicle key. In other exemplary embodiments, the identification can take place using a mobile phone, the position of which is determined in the area of a specific vehicle seat, for example the driver's seat, in vehicle 1 and which is assigned to a specific user. The identification can also take place on the basis of an input by the user who logs in, for example, by an input using the touchscreen 2 via a login.

Depending on the operable functions, potential operational action types are determined in a further step S2, e.g., it is determined which types of operational actions a user can carry out in order to make certain inputs for operating the operable functions. In the exemplary embodiment, different operating modalities are first determined, for example three-dimensional gestures in the detection area 7, gestures on the touch-sensitive surface 4, voice commands and/or actuation of physical operating elements such as keys, pushbuttons and rotary switches, sliders and knobs or buttons.

In a further step S3, preferred operational action types are determined, whereby in the exemplary embodiment the operational action types of a certain preferred operating modality are determined as preferred. This means that it is determined which types of operational actions are particularly well suited in the current situation or for certain operable functions.

In the exemplary embodiment, the position of a vehicle seat on which a user is located is determined for this purpose. For this purpose, it can first be determined on which vehicle seat the user is actually located, for example by means of a seat mat or a detection device; furthermore, a specific vehicle seat can be assigned to the operating system or to a specific operable device 9 of vehicle 1. In the exemplary embodiment, it is assumed that the driver of the vehicle 1 is regarded as the and is in the driver's seat. Different operating modalities can be assigned as preferred to certain positions of the vehicle seat. If, for example, the driver's seat is in moved-back position, for example during an automatic drive, from which the controls on the dashboard of the vehicle 1 are far away, operating modalities can be determined as preferred which do not require actuation of controls arranged on the dashboard; for example, in this case control by means of voice commands or three-dimensional gestures may be preferred.

Alternatively or in addition, in a further exemplary embodiment, it can be determined which types of operational actions require a minimum physical effort for certain inputs or allow the fastest possible operation. For example, scrolling through a list may require several actuations of a physical or virtually displayed button, while analog operation by means of a swiping gesture along the touch-sensitive surface 4 or in the detection area 7 can be carried out much more quickly and with less effort. In a further example, jumping to a specific entry in a list can be carried out particularly quickly by means of a voice command, while the input of the entry using a keyboard requires multiple actuations.

In further exemplary embodiments, other parameters can alternatively or additionally be used to determine preferred types of operational actions or operating modalities, for example a manual or at least partially automatic driving mode, a type of road being traveled, a geographical environment or settings, inputs and preferences for the identified user or driver of the vehicle 1.

In a further step S4, an operating history for the identified user is detected. In the exemplary embodiment, the operating history includes information about through which operational action types the user has made inputs for certain operable functions in the past. It may further include information about the way in which the user carried out the operational actions, for example how well the inputs were recognized based on the operational actions of certain operational action types and to what extent a modified implementation of the operational actions would improve the recognizability. This means that the operating history includes information on whether the user has used operational actions of certain operational action types in the past in order to make certain inputs and how he performed these operational actions. For example, if in the past the user carried out operational actions of a certain operational action type imprecisely, such as by making a swiping gesture in three-dimensional space at too high a speed, over too short a distance and/or not in a sufficiently straight line. In the past, this led to the swiping gesture being recognized with only a low level of confidence, with it being possible, for example, to determine the amplitude of the swiping gesture or its direction with only low accuracy. In a further example, in the past the user uttered a voice command indistinctly, too quietly or too quickly. In a further example, when actuating a virtual operating element on the touchscreen 2, the user touched an area on the edge of the operating element, so that the input could not be clearly separated from actuating an adjacent operating element.

In the exemplary embodiment, the operating history is detected in such a way that it includes a prescribed number of inputs by the user. In further exemplary embodiments, a certain period of time can be specified or the number of operational actions taken into account in the past can be variably determined while the method is being carried out.

If it is determined on the basis of the operating history detected that the user normally uses a preferred type of operational action for operating and executes the corresponding operational action in a clearly recognizable manner, then in a further step S5 an operational action is detected, a corresponding control signal is generated and the device of a vehicle 1 is activated.

If, on the other hand, it is determined that the user has rarely or never used the preferred operational action type or that the user does not carry out the preferred operational action of the preferred type of operational action optimally, in a step S6 an output with a reference to the execution of the potential type of operational action is generated and output.

It should be made clear to the user that, for example, that the user is not performing potential gestures at all or incorrectly, or that the user could perform the operation with less physical effort. The output is now generated individually in the respective situation in such a way that reference is made to a type of operational action not carried out by the user, incorrectly carried out or not optimally carried out, for example a certain gesture.

In the example, when certain gestures are not used at certain points in the operation of a human-machine interface, the user is shown, for example, a schematic hand at these points, which shows the execution of the as yet unused gesture type. If the gesture of a certain gesture type is executed incorrectly or not optimally, the intended gesture is recognized and a schematic hand is also displayed that indicates the correct or more economical gesture execution in motion.

In other examples, the correct gesture execution is represented in a different way. Thus, for example, with the aid of holographic or autostereoscopic displays, a three-dimensional hand in front of a display or in another detection area can be used to display the correct gesture movement. One possible extension of the method is, in addition to the visual display, to supplement the visual suggestions with speech output. Thus, for example, gestures that have never been carried out in a certain operating situation but that the user correctly carries out and knows elsewhere can be given a message via speech output; for example “You can also perform a swipe gesture here”. If the gesture is executed incorrectly or not optimally, spoken information on execution and improvement can be given; for example, “You have to keep the gesture very short at the end” or “You don't need to move your arm so far”. In this way, the problem of executing a type of operational action can be addressed in a more targeted manner and a natural interaction such as with a natural counterpart can be imitated.

Furthermore, when the identity of the user is detected, using a key or using biometric properties, the gesture operation and use of the various users can be addressed individually. For example, even when entering the vehicle, the system recognizes based on the operating history that the user is not performing a certain gesture in certain operating situations. In this way it can also be recognized that the user has already had problems in the past in executing a certain gesture correctly or with little physical effort. Individual support for optimal gesture operation can then be achieved for the user.

FIG. 3 shows an example of an output with a reference to the execution of the potential type of operational action. In the case shown there by way of example, the preferred operational action types is a swiping gesture in three-dimensional space, by means of which various graphic objects 22 to 25 can be shifted within a user interface 20, in particular in order to bring an element into the foreground, select it and then continue to operate it. The reference to such a swiping gesture is shown schematically in an outlined representation of a hand 21. The output is formed dynamically, e.g., the hand 21 represented schematically is shown moved in the manner in which the swiping gesture is to be carried out in three-dimensional space. In the user interface 20 of the exemplary embodiment, however, operation can also be in a different manner by means of non-preferred operational actions, such as by pressing arrow keys, by a swiping gesture along the touch-sensitive surface 4, by a voice command or by actuating a physical operating element, such as a rotary push button.

In the exemplary embodiment, the output may also be formed as a function of how the user can improve his execution of operational actions of the preferred operational action type, e.g., aspects of the execution are shown particularly clearly where there is a need for improvement. For example, the hand position can be shown particularly clearly during the gesture, as can the speed or the amplitude of the movement, for example over a particularly long distance.

In a further exemplary embodiment, the representation of the reference to the execution of the potential type of operational action is made by outputting a written notice. In further exemplary embodiments, the output can be done by means of a holographic or autostereoscopic display, in particular in order to represent three-dimensional gestures. In further exemplary embodiments, the output can alternatively or additionally be perceptible acoustically, for example through a spoken reference to the execution of the preferred type of operational action. In particular, the output can take place by means of an output modality that indicates a preferred operating modality, for example by outputting an acoustically perceptible reference to the operation by means of voice commands or by highlighting an actuatable physical or virtually displayed operating element, for example by a brightness, color or a dynamic effect like blinking.

After the output, in a further exemplary embodiment in Step S5, an operational action by the user can be detected as input and a corresponding control signal can be generated in order to operate the device 9 of the vehicle 1. The operation can also take place by means of an operational action of a non-preferred operational action type.

The operating history may be updated, based on the operational action detected.

In a further embodiment of the method according to the present disclosure, an operational action of a user is detected, for example a gesture in the detection area 7 or a voice command, although none of the operational actions currently available is assigned to the operation of a device 9 of the vehicle 1. This may be due to the fact that the operational action was not correctly recognized and assigned to an incorrect operational action type or that the user performed an operational action of an unavailable operational action type, for example because he is not aware of which operational action types are currently available or how they are to be carried out. An intention hypothesis is determined, e.g., the system forms a hypothesis about which type of operational action was probably intended by the user. The output is then generated with a reference to operational action types intended according to the intention hypothesis.

For example, that operational action type can be determined as the intention hypothesis which exhibits the greatest similarity to the operational action detected. This also takes into account which potential operational action types are actually currently available. Furthermore, those types of operational actions that the user prefers to use can be taken into account on the basis of the operating history, or it can be determined whether the operational action detected has particular similarities to operational action detected in the past in which the user did not optimally carry out a certain type of operational action.

For example, a voice command can be detected as an operational action that has a tonal or semantic similarity to a potential type of operational action, which is then determined as an intention hypothesis. In a further example, a three-dimensional gesture can be detected as an operational action which has a direction that is currently not provided, for example a vertical direction instead of a horizontal direction, a type of operational action with a horizontal direction then being determined as the intention hypothesis.

In a further exemplary embodiment, a learning process is also carried out on the basis of the operating history and/or on the basis of a detected operational action, the recognition of the type of operational action being improved by the system. Methods known per se, such as machine learning, can be used for this purpose. In this way, the method recognizes both a need for learning for the user, who is enabled to optimally use a preferred type of operational action, and a need for the system to learn, for which the recognition of a specific type of operational action for the user is improved.

In a further exemplary embodiment, a pointing gesture by the user is detected in the detection area 7 and a direction is determined on the basis of the pointing gesture detected. It is determined which device 9 of the vehicle 1 the user is pointing to and this device 9 is selected. A subsequently detected operational action is treated as operating the selected device 9, e.g., a control signal for the selected device 9 is generated on the basis of the operational action. For example, the user points to a sliding door of the vehicle 1 and automatically opens or closes the sliding door by means of a sliding or swiping gesture in one direction. In a further example, the user points to a display of the vehicle 1 on which image data or user interfaces can be output, a subsequent operational action being treated as operating the output or the user interface. In this way, the number of available operational action types can be restricted to relevant operating options for a specific device 9.

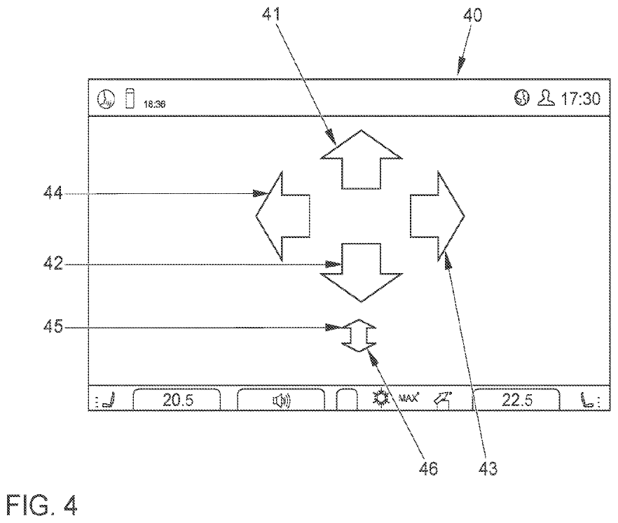

With reference to FIG. 4, an exemplary embodiment of an output generated in the method according to the present disclosure is explained with references to various directions. In this case, the explained exemplary embodiments of the operating system and method according to the present disclosure, which are further specified by the further exemplary embodiments, are used.

The output 40 according to the exemplary embodiment includes arrows 41 to 46, which each represent a spatial direction and are partially designed as double arrows. The arrows 41 to 46 output the spatial directions in which potential gestures can be carried out as operational actions. Depending on the specific operating situation and depending on which potential types of operational actions are provided by means of gestures, an arrow or several arrows 41 to 46 are displayed in output 40 at the same time. The arrows 41 to 46 can also be generated superimposed in addition to any other graphical representations within the output 40.

In further exemplary embodiments, it can additionally be output whether and in what way a gesture is carried out with a certain hand position while a gesture is being carried out, for example an open or closed hand, an upward, downward, forward or backward-facing palm, stretched or bent fingers or an orientation of the hand in space. This can be output through additional graphic objects or a specific design of the arrows 41 to 46. Furthermore, instead of the arrows 41 to 46, another representation of a graphic object can be used for the output, for example an operating object such as a hand, in particular schematically by means of outlines. The representation can also be generated dynamically.

In the exemplary embodiment, arrows upward 41 and downward 42 represent gestures that include a movement from top to bottom. Such gestures can be used to implement scrolling in the vertical direction up or down, for example. Furthermore, arrows to the right 43 and to the left 44 stand for gestures with a movement to the respective side. By means of such gestures, for example, paging or shifting to one side can be implemented. Gestures that include a movement parallel to the surface of the output 40 are referred to in particular as swipe or “swipe” gestures.

Furthermore, arrows shown in perspective are provided to the rear 45 and to the front 46, e.g., in particular towards the display area of the output 40 or away from it. These arrows 45, 46 are shown in particular in perspective, with methods of graphical representation known per se being used in such a way that a spatial impression is created for the viewer of the output 40 such that an arrow pointing backwards 45 or forwards 46 points into the plane of the output 40 in and thus away from the viewer or out of the plane of the output 40 and thus towards the viewer.

In further exemplary embodiments, other arrow shapes are conceivable, in particular straight or curved courses, by means of which, for example, the execution of a gesture with a certain trajectory, such as a circular path or a segment of a circle, is indicated. Furthermore, in other exemplary embodiments, the output can be formed in such a way that it indicates that at the beginning and/or end of the execution of a gesture, for example, a swipe or

another movement, a pose of the actuation object should be held for a longer or shorter period of time. In this way, for example, the end of a movement for an input can be marked by means of a gesture.

In the exemplary embodiment, a gesture set is used for gesture operation that is restricted to certain types of operational actions, e.g., to certain types of gestures. In particular, the gesture set is designed so that the complete operability of an infotainment system is made possible. By means of such a gesture set, an entire system, in particular hierarchically structured data and operating levels, can be operated, instead of only operating parts within individual contexts. Such a gesture set includes, in particular, a manageable number of gestures so that the user can remember them. At the same time the gestures of such a gesture set formed in such a way that they can be distinguished from one another particularly clearly and easily detected, for example by means of a camera.

In the exemplary embodiment, the gesture set may include five basic gestures. A graphic display with graphic objects 41 to 46 is explained with reference to FIG. 4, by means of which references to the basic gestures can be output.

In the case of a “swipe, horizontal” gesture a hand, especially in the upright position, moves in a horizontal direction to the right or left, in particular relative to an operating object that is output, for example, on a display area or within the output 40. Holding the pose of the hand at the end of the gesture leads in particular to a permanent function, for example in that a permanent actuation is detected. In the case of a “swipe, vertical” gesture, a hand moves in a flat or lying position in a vertical direction upwards or downwards, in particular relative to the operating object. Here, too, holding the pose of the hand at the end of the gesture can lead, in particular, to a permanent function, for example by detecting a permanent actuation. In the case of an “OK” gesture, a hand moves with the palm upward, with the fingertips in particular pointing in the direction of the operating object, which is displayed on a screen, for example. In the case of a “stop” gesture, a hand moves in an open position and with the palm of the hand towards the operating object, in particular in a direction towards the operating object. Here, too, a pose of the hand can be held at the end of the gesture and detected as a permanent actuation.

Finally, with a “volume” gesture, an index finger can point to the operating object and, for example, be moved in a lateral direction. To make it easier to remember, most of the basic gestures mentioned can be performed in pairs in opposite directions. By means of a swipe gesture, for example, one can move both to the right and to the left or swipe up or down. Selecting or actuating the operating object, for example to get to a certain hierarchical level or a certain menu or to confirm a request, is done by moving towards the body, leaving a hierarchical level or a menu or rejecting a request is done by moving in the opposite direction away from the body.

These paired gestures are used to enable complete navigation through a large number of hierarchically ordered menus or other hierarchical levels and correspond to the three spatial directions in three-dimensional space. The possibilities of spatial gestures are thereby exhausted on the basis of all three dimensions. This additional dimension enables better structuring of the content compared to known operations with a two-dimensional operation, such as via touchscreen, and corresponds to the spatial thinking of the user to a greater extent.

The above-cited basic gestures for navigating through menus or hierarchically ordered elements follow the principle that the element to be operated does not have to be selected on the screen beforehand, for example by a pointing gesture to a specific object. Instead, in particular one element of the output is always already selected. The gesture is then evaluated as an input directly related to this element. For example, an “open” process can be carried out directly for an operating object that is displayed in the center of a display area and is already automatically selected, for example by means of an “OK” gesture. In order to select the operating object, it can be moved to the center of the display area or to another automatic selection area by means of a swipe gesture. In a vehicle in particular, this has the advantage that content can be selected reliably and easily, even if, for example, vibrations while driving make precise navigation difficult, in contrast to, for example, known operations using a cursor or a touchscreen.

In the case of the gesture set explained above, it is also provided that a volume or another parameter of the system is controlled by means of a corresponding “volume gesture”.

For example, the user points with an outstretched index finger or an actuating object in the direction of the operating object or a display surface. The volume control can be indicated by displaying a volume indicator as a popup, whereby a volume level can be regulated by moving the finger sideways. The volume display follows in particular the movement of the finger and the volume is increased or decreased.

Furthermore, option gestures can be defined that are not used for menu navigation, but rather serve as shortcuts for calling up certain functions. In particular, three option gestures are provided, namely to jump directly to the home screen (stop gesture with making a fist at the end), to call up a tutorial that shows and explains the gestures and their functions (wave) and to mute a sound playback (movement of the open hand downward). In the exemplary embodiment, the option gestures always lead to the calling up of the same function, regardless of the particular context in which they are executed.

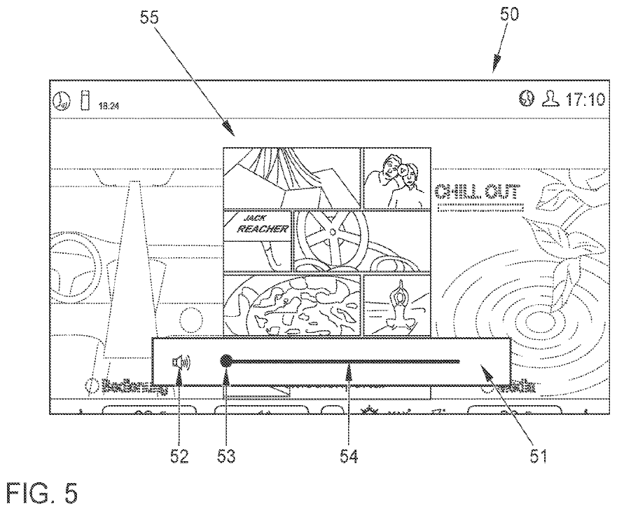

With reference to FIG. 5, an exemplary embodiment of an output generated in the method according to the present disclosure with a pop-up for volume control is explained. Here the explained exemplary embodiments of the operating system and method according to the present disclosure that are further specified by the further exemplary embodiments are assumed.

The output 50 according to the exemplary embodiment comprises a graphic object 51, which here stands for a media file currently being played, as well as a volume operating object 51, which is output as a popup overlaying the other elements of the output 50. The volume operating object 51 comprises a volume symbol 52 and a scale object 54, which is designed as a horizontal straight line, with different positions of the different values of the volume assigned to the longitudinal extent, in particular a volume increasing from left to right. A pointer object 53, here a filled circle, is arranged on the scale object 51, the position of the pointer object 53 on the scale object 51 indicating the currently set value of the volume.

In the exemplary embodiment, a user arrives at the displayed output 50 when, during the playback of a media file displayed by the graphic object 55, he points his extended index finger at the output 50 and performs a horizontal movement. In accordance with the movement of the index finger, in particular proportionally thereto, the pointer object 53 in the output 50 is shifted along the scale object 51 and the set value of the volume is changed to the same extent.

In the exemplary embodiment, the volume operating object 51 can also be operated by touching the touchscreen 2, which outputs the output 50. The user can, for example, touch the pointer object 53 and move it along the scale object 54 by means of a swiping gesture along the touchscreen 2. Furthermore, by touching the scale object 54, he can set the value of the volume assigned to this position, the pointer object 53 being moved to the position of the touch.

The above-described pointing gesture by means of an extended index finger in the direction of the output 50, followed by a movement in the horizontal direction, is performed in the exemplary embodiment is referred to in particular as a “volume gesture”. This is in particular an option gesture that can be used in the exemplary embodiment independently of the context currently output. That is, regardless of what is output in the output 50, by means of the volume gesture the currently set volume can be displayed and changed. This simplifies the operation, since a certain context or content has to be called up in order to change the volume.

In particular, the volume gesture and further option gestures can be used in the example in any context, e.g., independently of the currently active display or a currently selected operating object. For example, the volume gesture for volume control and a gesture for muting affect the volume of the currently active acoustic context, similar to, for example, known analog volume controls that use a rotary control, for example.

In some examples, various operating modalities can be used in order to operate functionalities. In particular, preferred operating modalities are determined which, depending on the specific situation, indicate in which way an operation can be carried out particularly advantageously. By means of the preferred operating modality, the operation can, for example, be carried out particularly safely, quickly, with less physical effort and/or without excessive stress on the user's concentration.

Possible operating modalities are, for example, actuation or execution of gestures while touching a surface or an operating object, gestures in three-dimensional space, actuation of analog operating elements such as switches, buttons or controllers, voice commands, using a remote control or gesture control in conjunction with voice commands.

The operation of an infotainment system can, for example, be made possible entirely via different modalities in order to allow a user the personally preferred operating mode. Some users prefer voice control, others prefer gesture control. In this way the user can further freely choose one or the other modality depending on the situation, for example a gesture instead of speech, so as not to disturb a sleeping passenger. Furthermore, in the example, it is suggested to the user which type of operational action and/or which operating modality is currently best suited for the functions that can currently be operated. In the exemplary embodiment a preferred operating modality is determined using the following logic:

A gesture operation can be a preferred operating modality especially when there is a “fuzzy” operating target that cannot be specifically named, e.g., when the user, for example, carries out a search or navigates through a series of objects (“browsing”) and when an exact name, for example of one point of interest would be cumbersome to enter. Gesture operation can also be preferred for short interactions or if speech interruptions are disturbing in a particular situation. It can also be preferred for spatial selection or spatial operation.

Operation by means of voice commands can be particularly advantageous if the operating target can be clearly identified, for example if the user can easily pronounce a name for a function or device to be operated. The user can also jump over several hierarchical levels particularly easily by means of voice commands without first having to carry out a lengthy search. Furthermore, natural language inputs can be provided.

Operation by means of a remote control can then be preferred if operation that is particularly familiar to the user is to be guaranteed.

Operation by means of a combination of gestures and voice commands can then be preferred if one wishes to interact with a unit the naming of which is unclear or cumbersome or if a special operational action is required to activate the voice control, such as pressing a button or a specific code word, is to be bypassed.

In the example, gesture operation is determined as the preferred operating mode when a search or browsing is to be carried out, for example to search for a name or an address or to carry out a search within a list of film or music titles. Gesture control is also preferred for short interactions, such as accepting a phone call, for operating controls or environmental elements that are easiest to select spatially or the name of which is not known, for example to operate a specific window or set a specific lighting device, as well as if an interruption by a voice command would disturb, for example during a phone call or if a passenger would be disturbed.

In particular, in the example of the system, although several operating modalities are supported for one operation, the output indicates the most suitable type of operation in each case.

For example, gesture operation for accepting an incoming call is indicated by using visual elements for various operating options represented in a similar manner dynamically to show how an associated operating gesture is to be performed. In particular, a movement of the operating elements is shown in the directions in which the corresponding gestures are to be carried out. At the same time, however, the operating elements in the example can also be operated themselves, such as by touching a display surface in the area of the operating elements. In further examples, the option of voice control can also be provided; an indication of the corresponding option is then output, for example, by means of a displayed text that reproduces the corresponding voice command, or by means of a symbol for the voice control.

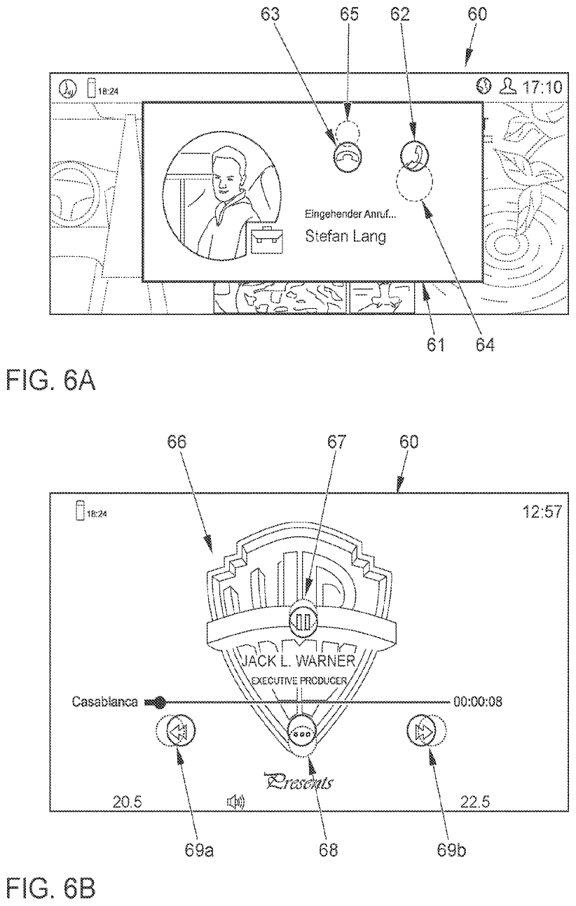

With reference to FIGS. 6A and 6B, exemplary embodiments of the outputs generated in the method according to the present disclosure with references to the execution of operating gestures are explained. Here t explained exemplary embodiments of the operating system and method according to the present disclosure are assumed, which are further specified by the further exemplary embodiments.

In the case shown in FIG. 6A, the output 60 according to the exemplary embodiment comprises a popup 61, which is output overlaying the other elements of the output 60. In the area of the pop-up 61, information about an incoming call is output, in particular the name of the caller and a profile picture, this information being assigned to a database with contacts and associated additional information. The pop-up 61 further comprises an operating element 62 for accepting and a further operating element 63 for rejecting the incoming call.

In the exemplary embodiment, the operating elements 62, 63 can be operated by tapping gestures, the user briefly touching the touchscreen 2 of a position of the respective operating element 62, 63 in order to carry out the respectively assigned function. Moreover, gesture control is provided in the exemplary embodiment. In the example, it is determined that the gesture operation represents the preferred operating modality, that is to say operation for accepting or rejecting the call is preferably carried out by a gesture assigned to each of these functions. In the exemplary embodiment, this preference is due to the fact that the seated position of the user is far away from the touchscreen 2 and it can therefore be touched only with difficulty.

The gestures for accepting or rejecting the call are output in that the operating elements 62, 63 are displayed dynamically. This is indicated in FIG. 6A by dynamic objects 64, 65. To accept the call, the user should make a gesture in which he moves his hand away from the output 60 in a direction perpendicular to the plane, for example corresponding to a “waving in,” “pulling” or “fetching” gesture. Conversely, to reject the call, the user should perform a gesture in which he moves his hand in a direction perpendicular to the plane of the output 60, for example in accordance with a “push away”, “denial” or “rejection” gesture. The corresponding operating elements 62, 63 are shown dynamically and in perspective in such a way that they appear to have a movement in a direction that corresponds to the respective movement of the gesture.

In further exemplary embodiments, the output 60 is generated by means of a three-dimensional representation technique, for example by means of an autostereoscopic or holographic representation.

In the case shown in FIG. 6A, an animated output is generated which comprises controls for accepting and rejecting the call, wherein the operating elements are shown moved in the direction of the gesture to be performed. By means of a perspective representation, a movement of the operating objects away from the driver or towards the driver is shown, with a red (reject) and green (accept) circle appearing to move spatially in the display by means of numerous smaller or larger circles.

In the case shown in FIG. 6B, the output 60 includes a background representation 66, which here corresponds to a playback of a video file. The output 60 further includes operating elements 67, 68, 69a, 69b which, like the operating elements 62, 63 in the case of FIG. 6A, can be actuated both by touching the touchscreen 2 and also serve to output information about potential operating gestures. In the exemplary embodiment, the operating elements 67, 68, 69a, 69b are displayed in particular when an operating intention has been detected, for example when an actuating object enters the detection space 7 or when the touchscreen 2 is touched.

As already explained above with reference to FIG. 6A, the operating elements 67, 68, 69a, 69b are also represented dynamically here. They show movements that correspond to the movements of potential operating gestures. For example, an operating element 67 for stopping the playback is provided and designed with a corresponding symbol. The operating element 67 is also represented animated in such a way that it appears to be moving away from the user. The corresponding operating gesture for stopping accordingly includes a movement toward the output 60, roughly corresponding to a “push” gesture. In the exemplary embodiment, the operating element 68 for calling up a context menu is also shown moved downward and the corresponding operating gesture comprises a downward swipe. The operating elements 69a, 69b for rewinding (operating element 69a) or forwards (operating element 69b) are represented animated with movements to the left and right, which here also corresponds to the movement of the respective operating gestures, in particular swiping gestures.

In further exemplary embodiments, the operating gestures can also be designed in a different manner or combined in different ways. In particular, the gestures provided are based on the set of basic gestures explained above with reference to FIG. 4, optionally supplemented by the option gestures also explained above.

In the example, gesture operation is used not only to navigate through a menu hierarchy, but contexts are also operated. Due to the difference in contexts, different functions are provided. As explained above with reference to FIGS. 6A and 6B, an incoming telephone call can be accepted or rejected, for example. Furthermore, a movie that is currently being played back can be trained or paused in both directions. Moreover, a context menu can be selected to set additional options, such as subtitles or a language. The variety of necessary functions is operated by means of the gesture set explained above whereby, for example, declining a phone call is made with the same stop gesture as pausing a film. So that the user knows in which context which operating options are available to him, depending on context the user is shown which gestures are possible and which function they each have. It can also be output which is the preferred operating modality.

Thus, in the exemplary embodiment for an incoming call, two operating objects 62, 63 represented as “bubbles” are displayed, in the example of a film several operating objects 67, 68, 69a, 69b as bubbles. These bubbles each contain a symbol and optionally a color, whereby the function is output. For example, a handset symbol in red color stands for ending the call or a pause symbol stands for pausing. The bubbles also move in the direction in which the corresponding gesture is to be carried out, e.g., to the right or left, up or down, or in perspective towards or away from the user.

With the display concept, the user is informed of the available operational action types of the gesture control or other preferred operational action types in that these are displayed in a context-specific manner. This reduces the memorization effort for the user and the number of unwanted operations is reduced.

The representations described above with reference to FIGS. 6A and 6B are particularly well suited, can be easily and intuitively grasped by the user, but at the same time not conspicuous and subtly signaling which operating options he has in the respective operating situation. Alternatively or in addition, other outputs can be used to prompt the user to use certain operating gestures. For example, the arrows 41 to 46 described above with reference to FIG. 4 can be output, although such additional objects are often perceived as disturbing. The spatially represented movement of elements in the direction of the gesture, on the other hand, can also be output without additional graphic objects, so that the user interface that is output is not overfilled.

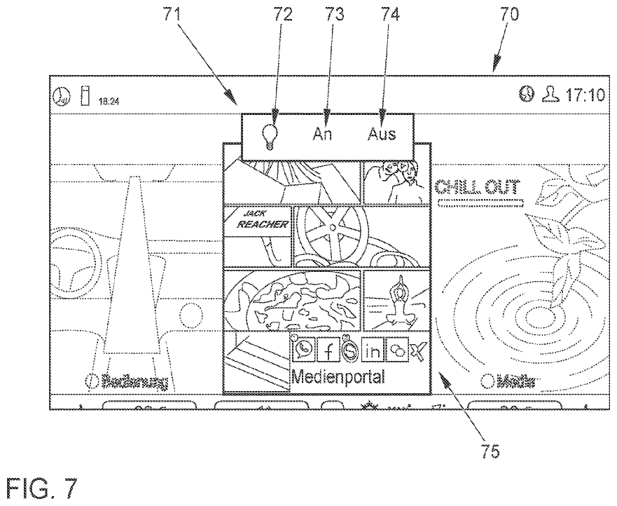

With reference to FIG. 7, an exemplary embodiment of an output generated in the method according to the present disclosure with a popup for controlling a lighting device is explained. It is based on the explained exemplary embodiments of the operating system and method according to the present disclosure, which are further specified by the further exemplary embodiments.

The output 70 according to the exemplary embodiment comprises a graphic object 75, which here stands for a media file currently being played, as well as a popup 71, which is output overlaying the other elements of the output 70. The popup 71 includes a brightness symbol 72 and operating elements 73, 74 for switching on or switching off a lighting device.

In this example, a user arrives at the displayed output 70 when, during the playback of a media file displayed by the graphic object 75, he points his extended index finger at a device in the vehicle 1 and holds this pointing gesture for a prescribed time. According to the direction of the index finger, it is determined to which device of the vehicle 1 the user is pointing, in the exemplary embodiment a lighting device. Pop-up 71 is then generated, which comprises operating elements 73, 74 which indicate the possible operations. In the exemplary embodiment, there are also various potential operating modalities here, in particular touching the touchscreen 2 in the area of the operating elements 73, 74 or voice commands. In the exemplary embodiment, further operation by means of voice commands is preferred, for the execution of which the operating elements 73, 74 are designed as text elements. This shows the user which voice commands he can use to operate the device.

In addition to this, in the exemplary embodiment, an operation can also be carried out by means of a further pointing gesture, the user pointing to one of the operating elements 73, 74 within the popup 71 in order to operate it and trigger the function linked to it. Furthermore, it can be provided that an operation by means of a further operating gesture can be performed, such as a swipe down to switch off or up to switch on.

In the exemplary embodiment shown in FIG. 7, an operation can thus preferably be carried out by means of a gesture in combination with a voice command. This operating modality is determined to be preferred when a device of the vehicle is to be operated without using a specific wake-up phrase to activate pure voice operation. In this example, the user points to the device to be operated, which in the example is a light in the interior of the vehicle. He then continues to operate using a voice command. In order to indicate to the user after the pointing gesture that voice operation can be carried out, a popup with the possible language options is displayed.

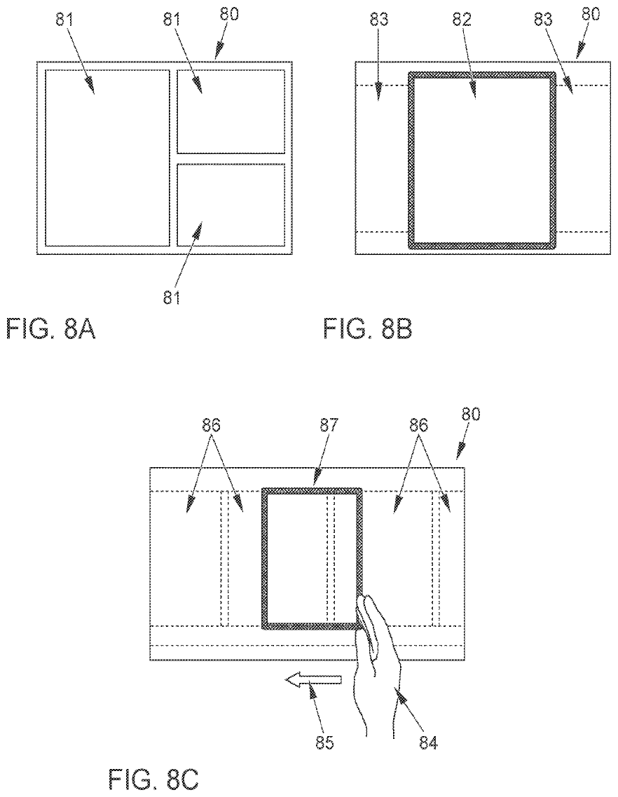

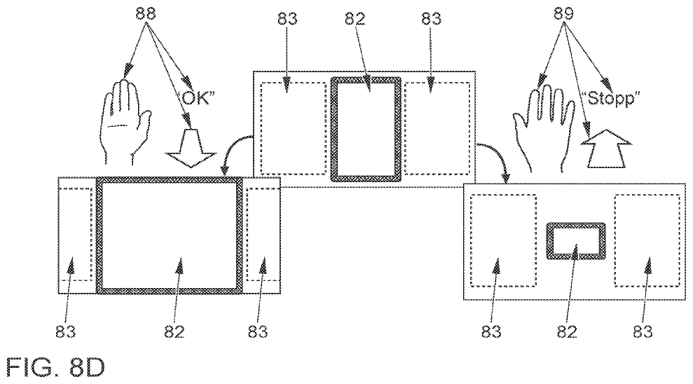

With reference to FIGS. 8A to 8D, an exemplary embodiment of an output generated in the method and its operation in different operating modes are explained. It is based on the exemplary embodiments of the operating system and method according to the present disclosure explained, which are further specified by the further exemplary embodiments.

In the case shown in FIG. 8A, the operating system is in a close-range mode, e.g., the user is placed with his seat within reach of the touchscreen 2. The output 80 comprises several widgets 81 which are arranged next to and above one another in the manner of a matrix. In this exemplary embodiment, the preferred operating modality in the close-up mode is operation by touching the touchscreen 2 and possibly gestures along the touched surface of the touchscreen 2.

In the case shown in FIG. 8B, an automatic driving mode of the vehicle 1 was activated and the seat of the user, who no longer has to manually intervene in the control of the vehicle, was moved backwards. The touchscreen 2 is thus difficult to reach and the operating mode is therefore switched to a distance mode. The preferred operating modality is now operation using gestures in three-dimensional space, in particular in detection area 7 in the interior of vehicle 1. When the operating mode is changed, output 80 also changes so that the display is now optimized for the new preferred operating modality.

This means that in the exemplary embodiment, the operating system can be operated both by means of a touchpad and by means of gestures. In at least partially automatic driving modes, in particular with a level of automation of level 4 or level 5, in particular a driver's seat is moved backwards in order to enable greater seating comfort which, however, also complicates operation of a touchscreen on the dashboard due to the inability to reach the display. In this case, gesture operation should be provided as the preferred operating modality. The display concept must be adapted for this, as not all displays are well suited for gesture operation. Furthermore, content that is too small would otherwise be difficult to see due to the greater distance of the seat.

In the example, a display optimized for gesture operation is displayed in a “distance mode” for seat positions far from the display. In the example, only three “contexts”, in the exemplary embodiment designed as tiles, widgets or windows, are displayed at the same time. These are shown sufficiently large to be recognizable from a greater distance.

Since a simpler structure of the display is useful for operation by means of gestures, the objects 82, 83 of the output 80 are now arranged next to one another. The object 82 arranged in the middle is always selected automatically, while the other objects 83 are arranged next to it. In the exemplary embodiment, the selected object 82 is also shown highlighted in that it is output with a larger area, a special border and, compared to the other objects 83, with greater brightness.

This means that in the display in distance mode, the contexts are arranged in one line, while they are arranged in several lines for touch operation. The middle context or the middle tile is always in focus, that is, it is always automatically selected, and is visually represented as larger, brighter and highlighted. This context can therefore be used immediately, for example to start a film represented in it, without having to select the context beforehand. In another exemplary embodiment, the contexts are arranged in several lines and are selected by means of a gesture, such as a pointing gesture, before opening or activating.

The case shown in FIG. 8C represents how a user, by a lateral swiping gesture with his hand 84 in a direction shown by an arrow 85, undertakes the shifting of the graphic objects shown in output 80. Here the selected object 87 is shifted laterally from the center and another object 86 moves into its place, where it is now automatically selected. In the exemplary embodiment it is provided that, in addition to the lateral swiping gesture in three-dimensional space, a swiping gesture along the touch-sensitive surface of the touchscreen 2 and/or a voice command can also be used to shift the objects 86, 87.

In the case shown in FIG. 8D, starting from the situation shown in the middle, the navigation is represented by a hierarchically arranged database or a menu structure. In addition, the contents of an infotainment system can be structured hierarchically. For the current object 82 shown in the center and therefore automatically selected, the user can undertake an activation such that it is activated or opened or that a change is made to a subordinate hierarchical level; the potential types of operational action that can be used for this purpose are represented by instructions 88, which can also be represented in the output 80 in an analogous manner. The user can also stop a process for the selected object 82 or switch to a superordinate hierarchical level; the potential types of operational actions that can be used for this purpose are represented by instructions 89.

To activate or open a context or to switch to a subordinate hierarchical level, instructions 88 show the option of operation using a three-dimensional hand gesture, with the palm facing the user and a movement being made towards the user. Alternatively or additionally, the voice command “OK” can be used. Conversely, the instructions 89 for stopping or changing to a superordinate hierarchical level show an indication of a three-dimensional hand gesture in which the palm of the hand points to the touchscreen 2 or to the output 80 and a movement is carried out towards the output 80. Alternatively or additionally, the voice command “Stop” can be used.

FIG. 8D further shows how the transitions between the hierarchical levels of the data base are represented: Starting from the starting situation represented in the middle, in operation in accordance with instructions 88, for example with an “OK” gesture, the selected object 82 is enlarged and the other objects 83 are displaced from the display. The representation thus corresponds to the selected object 82 coming closer to the user or a movement from the user's perspective towards the selected object 82. Further objects of the subordinate hierarchical level are then displayed in the same way as shown in the middle in FIG. 8D, that is to say a middle object is automatically selected and other objects are arranged next to it. Conversely, when operating in accordance with the instructions 89, for example with a “Stop” gesture, the selected object 82 is reduced in size, with the other objects 83 also being able to be reduced in size. Conversely to the case explained above, this corresponds to removing the selected object 82 from the user, or the user appears to be moving away from the selected object 82.

The output 80 is generated in particular in such a way that the selected object 82 and the other objects 83 are displayed next to one another in such a way that the objects of different hierarchical levels or menu levels appear arranged one behind the other. The output 80 is generated in particular in perspective such that an arrangement is represented along a three-dimensional structure, for example along concentric rings or rollers. When changing the hierarchical level or menu level, the perspective of the view represented moves to the objects of the other hierarchical level.

Contexts or objects 82, 83 on the same hierarchical level are shown in the exemplary embodiment, as on a carousel, laterally next to one another and slightly offset in perspective to the rear. The outer tiles or objects 82, 83 are shown cut in order to make it clear that there is further content next to them. When a context or an object 82 is opened, a change is made to a lower menu level and the corresponding tile is zoomed in, the selected, middle tile being briefly enlarged. Subsequently, a reduction in size up to a renewed representation of three contexts is shown on the then lower menu level.

Closing a context or object 82 and thus changing to a higher menu level is output as a perspective removal of the tile. For this purpose, the middle, automatically selected or object 82 is reduced in size in the display and then there is again an enlargement up to the renewed display of, for example, three contexts on the then higher menu level.

The visual animations described output to the user as visual support, as to the operating direction in which the user is moving through the menu hierarchy, so that he gets a better orientation about the menu structure and his current position within the hierarchy.

In a further exemplary embodiment, list contents, for example entries in a telephone book, are output vertically rather than horizontally. Here too, a perspective arrangement of the entries along a roller or carousel structure is represented. The upper and lower elements are shown cut off to make it clear that there is further content next to them. A level change can be carried out as explained above with reference to FIG. 8D.

In addition to the visual support of the change of level, an output that can be perceived acoustically or haptically can also be generated.

### LIST OF REFERENCE SYMBOLS

1 vehicle
2 touchscreen
3 output unit; display unit
4 detection unit; touch-sensitive surface
5 detection unit; camera
6 output unit; loudspeaker
7 detection area
8 control unit
9 device; multimedia unit
20 user interface
21 schematic representation of a hand
22 to 25 graphic object
S1 to S6 step
40 output
41, 42 arrow (“swipe, vertical”)
43, 44 arrow (“swipe, horizontal”)
45, 46 arrow (perspective)
50 output
51 volume operating object
52 volume symbol
53 pointer object
54 scale object
55 graphic object
60 output
61 popup
62 operating element (accept)
63 operating element (reject)
64 dynamic object (forward)
65 dynamic object (backwards)
66 background representation
67 operating element (stop)
68 operating element (context menu)
69a, 69b operating element (wind)
70 output
71 popup
72 brightness symbol
73 operating element (“On”)
74 operating element (“Off”)
75 graphic object
80 output
81 widget (near mode)
82 selected object
83 other object
84 hand
85 arrow
86 other object
87 selected object
88 references to “OK” gesture
89 references to “stop” gesture

1-10. (canceled)

11. A method for detecting a user input for a device of a vehicle, comprising:
detecting an operable function of the device;
determining a first and a second potential operational action type, based on the detected operable function;
determining a preferred type of operational action; and
generating an output depending on the preferred type of operational action, wherein the output comprises an operating object, in which the preferred type of operational action is displayed to a user.

12. The method according to claim 10, wherein the determined first and second potential operational action types are assigned to different operating modalities, wherein a preferred operating mode is determined and the preferred type of operational action is determined on the basis of the preferred operating mode.

13. The method according to claim 10, wherein the output, if the preferred operational action type includes a spatial gesture, comprises a moving object having a movement corresponding to a direction of the spatial gesture.

14. The method according to claim 10, wherein the output, if the preferred type of operational action includes a spatial gesture, comprises a schematic graphic representation of a hand.

15. The method according to claim 10, wherein the output, if the preferred type of operational action includes a voice command, comprises a text representation of the voice command.

16. The method according to claim 10, further comprising
detecting an operational action that cannot be assigned to a potential operational action type; and
determining an intention hypothesis based on the operable function and the operational action detected, wherein the output is generated based on the intent hypothesis.

17. The method according to claim 10, further comprising detecting a user position relative to an input device, wherein the preferred type of operational action, depending on the user position, comprises an actuation of the input device or a spatial gesture.

18. The method according to claim 10, wherein the output is output visually, acoustically or haptically.

19. An operating system for detecting a user input for a device of a vehicle, comprising:
a control unit; and
an output unit operatively coupled to the control unit, wherein the control unit and operating unit are configured to
detect an operable function of the device;
determine a first and a second potential operational action type, based on the detected operable function;
determine a preferred type of operational action; and
generate an output depending on the preferred type of operational action, wherein the output comprises an operating object, in which the preferred type of operational action is displayed to a user.

20. The operating system according to claim 19, wherein the determined first and second potential types of operational are assigned to different operating modalities, wherein a preferred operating mode is determined and the preferred type of operational action is determined on the basis of the preferred operating mode.

21. The operating system according to claim 19, wherein the output, if the preferred operational action type includes a spatial gesture, comprises a moving object having a movement corresponding to a direction of the spatial gesture.

22. The operating system according to claim 19, wherein the output, if the preferred type of operational action includes a spatial gesture, comprises a schematic graphic representation of a hand.

23. The operating system according to claim 19, wherein the output, if the preferred type of operational action includes a voice command, comprises a text representation of the voice command.

24. The operating system according to claim 19, wherein the control unit and operating unit are further configured to
detect an operational action that cannot be assigned to a potential operational action type; and
determine an intention hypothesis based on the operable function and the operational action detected, wherein the output is generated based on the intent hypothesis.

25. The operating system according to claim 19, wherein the control unit and operating unit are further configured to detect a user position relative to an input device, wherein the preferred type of operational action, depending on the user position, comprises an actuation of the input device or a spatial gesture.

26. The operating system according to claim 19, wherein the output is outputted visually, acoustically or haptically.

29. A method for detecting a user input for a device of a vehicle, comprising:
detecting an operable function of the device;
determining a first and a second potential operational action type, based on the detected operable function, wherein the determined first and second potential types of operational types are assigned to different operating modalities, wherein a preferred operating mode is determined and the preferred type of operational action is determined on the basis of the preferred operating mode;
determining a preferred type of operational action; and
generating an output depending on the preferred type of operational action, wherein the output comprises an operating object, in which the preferred type of operational action is displayed to a user.

30. The method according to claim 29, further comprising
detecting an operational action that cannot be assigned to a potential operational action type; and
determining an intention hypothesis based on the operable function and the operational action detected, wherein the output is generated based on the intent hypothesis.
